(19) United States
(12) Patent Application Publication
(10) Pub. No.: US 2014/0376910 A1
(43) Pub. Date: Dec. 25, 2014

(54) APPARATUS FOR FIBER OPTIC PERTURBATION SENSING AND METHOD OF THE SAME

(71) Applicant: FIBERPRO, INC., Daejeon (KR)

(72) Inventors: Hyo Sang Kim, Gumi (KR); Ho Jin Jeong, Daejeon (KR); Jae Chul Yong, Suwon (KR)

(21) Appl. No.: 14/360,921

(22) PCT Filed: Dec. 14, 2012
(86) PCT No.: PCT/KR2012/010875

§ 371 Date: May 27, 2014

(30) Foreign Application Priority Data
Jan. 6, 2012 (KR) 10-2012-0002029

(51) Int. Cl. H04B 10/07; H04B 10/071

(52) U.S. Cl. CPC H04B 10/0705; H04B 10/071
USPC 398/28

(57) ABSTRACT

The present invention relates to an apparatus and a method for fiber optic perturbation sensing, in which it is possible to easily confirm whether an intrusion is occurred, an intrusion position, and an intrusion object by dividing an optical signal output from the optical signal generation unit, progressing the divided optical signals to optical paths having different lengths, coupling the divided optical signals to generate an sensing optical signal, outputting the generated sensing optical signal to the sensing optical fiber, dividing the sensing optical signal returning from the sensing optical fiber, progressing the divided sensing optical signals to the optical paths having different lengths, and coupling the divided sensing optical signals to generate an interference sensing optical signal.

### TECHNICAL FIELD

The present invention relates to a sensing apparatus using an optical fiber, and more particularly, to a sensing system capable of sensing external disturbances applied to a sensing optical fiber with high sensitivity using an interferometer.

### BACKGROUND ART

Generally, when a man monitors intrusion or damage, damage due to aging or impact, and the like, a lot of people and costs are required. Further, when surveillants are careless or leave their seats for a while, precautions may fail and surveillants may substantially be impossible to monitor intrusion in bad weather or at night when a field of vision is incomplete.

Therefore, a necessity of an automatic monitoring system which uses an assistance device for a man to monitor military boundaries or important facilities or sensors to perform unmanned surveillance for less important facilities is on the rise. To this end, an infrared camera, a close-circuit television (CCTV), and the like have emerged. In this case, however, since the number of cameras and monitors is increased in proportion to the number of monitoring points, the number of monitoring points involves an absolute limitation and since the residence of surveillants is required, the intrusion surveillance may fail when the surveillants leave their seats or are careless for a while.

To solve the problem of electronic surveillance, an automatic intrusion surveillance which uses an optical fiber constructed in the air of a boundary line at a proper height and an optical time domain reflectometry (OTDR) measuring instrument has been attempted.

In the case of the intrusion monitoring using the optical fiber, when the optical fiber constructed in the air of the boundary line is cut by an intruder, the OTDR measuring instrument confirms intrusion occurrence and intrusion location by using the fact that no reflection due to Rayleigh scattering exists in a region after the cut portion of the optical fiber.

Meanwhile, as a sensing method using another type of optical fiber disturbance sensing sensor, there are a method for monitoring a change in intensity of reflected light when an intruder applies a pressure to a special optical fiber made by adding rare earth elements into the optical fiber, a method for confirming an intrusion place and issuing an automatic alarm by sensing an interference of reflected light from two inferface surfaces between different refractive indexes regions generated by a change in refractive index of the optical fiber applied with a pressure by an intruder using the OTDR, and the like.

However, the optical fiber mounted as described above is easily cut by an intruder, a passer, natural causes such as a wind, other animals, and the like and therefore has many difficulties in an actual operation and requires a lot of costs and people for maintenance.

Generally, in the case of the intrusion sensing system using the optical fiber and the OTDR, the optical fiber constructed in the air has a weak strength and therefore may be easily cut by passing animals, trees shaken with wind, and the like. In the case of using a thick optical fiber with reinforced strength to supplement this problem, the optical fiber is exposed by an intruder or is not broken when being broken, and therefore may not appropriately perform the intrusion sensing. Further, once the optical fiber is broken, the optical fiber may not be reused until professional manpower repairs the optical fiber and may not be commercialized since automatic alarm function or report function is not present.

Meanwhile, a method for monitoring the intensity of reflected light due to the pressure applied when an intruder passes through the special optical fiber buried in the ground can protect the special optical fiber, but since the change in the intensity of reflected light is insignificant, the method is hardly used as an efficient personal sensing sensor. Further, the method for sensing the interference of reflected light from two inferface surfaces between different refractive indexes regions due to the change in refractive index of the optical fiber using the OTDR, and the like may not be easily commercialized since the sensitivity of the sensor is reduced and the sensor system is very expensive.

Therefore, a need exists for a sensing apparatus which may more easily confirm intrusion occurrence, an intrusion position, and an intrusion object.

### DISCLOSURE

### Technical Problem

The present disclosure provides a sensing apparatus capable of more easily confirming whether an intrusion is occurred, an intrusion position, and an intrusion object.

### Technical Solution

In one general aspect, the present disclosure provides an apparatus for fiber optic perturbation sensing, including: a sensing optical fiber configured to sense external disturbances; an optical signal generation unit configured to output a pulse type of optical signal; an optical interference unit configured to divide an optical signal output from the optical signal generation unit, progress the divided optical signals to optical paths having different lengths, couple the divided optical signals to generate a sensing optical signal, output the sensing optical signal to the sensing optical fiber, divide the sensing optical signal returning from the sensing optical fiber, progress the divided sensing optical signals to the optical paths having different lengths, couple the divided sensing optical signals to generate an interference sensing optical signal, and output the interference sensing optical signal; an optical receiving unit configured to convert the interference sensing optical signal output from the optical interference unit into an electrical signal and output the electrical signal; and a signal processing unit configured to analyze the electrical signal output from the optical receiving unit to detect a position and a kind of external disturbances applied to the sensing optical fiber.

The sensing optical fiber may include a reflection point using a plurality of optical fiber cables which are connected by a face contact/physical contact connector (FC/PC) or a reflecting point using an optical fiber grating.

The sensing optical fiber may include a polarization-maintaining optical fiber and an optical fiber with enhanced Rayleigh back scattering.

The optical signal generation unit may include: any one of a laser diode (LD), a super luminescent diode (SLD), an amplified spontaneous emission (ASE) light source using an erbium doped fiber (EDF), and a light emitting diode (LED). The optical signal generation unit may include an un-polarized light source or a light source of a short wavelength.

The optical interference unit may include: a first optical coupler configured to divide an optical signal input from the optical signal generation unit and output the divided optical signal to optical paths having different lengths, couple the optical signals input from the optical paths having different lengths, and output the coupled optical signal to the optical receiving unit; and a second optical coupler configured to couple the optical signals input from the optical paths having different lengths, output the coupled optical signal to the sensing optical fiber, divide the optical signal input from the sensing optical fiber, and output the divided optical signals to the optical paths having different lengths.

The first optical coupler may be a 2×2 optical coupler whose both ports of one portion are connected to the optical signal generation unit and the optical receiving unit and both ports of the other portion are connected to the optical paths having different lengths. The first optical coupler may be a 3×3 optical coupler whose middle port of one portion is connected to the optical signal generation unit, upper and lower ports of the one are connected to first and second optical receiving units, and upper and lower ports of the other port are connected to the optical paths having different lengths.

The second optical coupler may be a 2×2 optical coupler whose both ports of one portion are connected to the optical paths having different lengths and one port of the other portion is connected to the sensing optical fiber.

In the optical paths having different lengths, a difference between the paths may be longer than a pulse length of the optical signal.

The apparatus for fiber optic perturbation sensing may further include: a depolarizer configured to be provided in one path of the optical interference unit or between the optical signal generation unit and the optical interference unit. The apparatus for fiber optic perturbation sensing may further include: a phase modulator configured to be provided in one path of the optical interference unit.

The signal processing unit may divide a distance of the sensing optical fiber into a plurality of sections, samples signal values which are back scattered in each section for each order of pulses of the optical signal and received in the optical receiving unit, and store the sampled signal values in a memory.

The signal processing unit may sequentially read the signal values stored in the memory for each pulse for each distance of the sensing optical fiber to detect a change in a magnitude of a back scattered signal due to external disturbances at a specific point so as to determine whether the external disturbances are applied to points which are divided into the plurality of sections.

The signal processing unit may compare the signal values stored in the memory for each pulse train to detect frequency characteristics of the external disturbances.

The signal processing unit may compare the signal values stored in the memory for each position which is divided into the plurality of sections to detect the occurrence positions and the magnitude of the external disturbances.

The signal processing unit may average the signal values stored in the memory for a preset time and use the averaged values.

The signal processing unit may compare a value obtained by averaging the signal values stored in the memory while no external disturbance exist for a preset time with a value obtained by averaging the signal values stored in the memory while the external disturbances are applied for a preset time to determine whether the external disturbances are applied.

The signal processing unit may perform a determination on whether the external disturbances are applied, a detection of the frequency characteristics of the external disturbances, or a detection of the occurrence positions and the magnitude of the external disturbances, only when a Fresnel reflection signal generated at an end of the sensing optical fiber is changed.

In another aspect, the present disclosure provides a method for fiber optic perturbation sensing, including: a first step of dividing a pulse type of optical signal and progressing the divided optical signals through optical paths having different lengths; a second step of coupling the optical signals progressed to the optical paths having different lengths and outputting the coupled optical signal to a sensing optical fiber; a third step of dividing the sensing optical signal returning from the sensing optical fiber and progressing the divided sensing optical signals to the optical paths having different lengths; a fourth step of coupling the sensing optical signals progressed to the optical paths having different lengths to generate an interference sensing optical signal; and a fifth step of analyzing the interference sensing optical signal to detect a position and a kind of external disturbances applied to the sensing optical fiber.

In the first step, the optical signal may be subjected to two division and progress the divided optical signals to different optical paths having a path difference longer than a pulse length of the optical signal.

In the third step, the sensing optical signal returning from the sensing optical fiber may be subjected to two division and progress the divided sensing optical signals to the different optical paths in a reverse direction.

A preset constant phase difference may additionally occur between the optical signal which is progressed to a short optical path in the first step and then progressed to a long optical path in the third step and the optical signal which is progressed to the long optical path in the first step and then progressed to the short optical path in the third step.

In the fifth step, a distance of the sensing optical fiber may be divided into a plurality of sections, back scattered signal values may be sampled and stored in each section for each order of pulses of the optical signal, and the stored signal values may be sequentially read for each pulse for each distance of the sensing optical fiber to detect a change in a magnitude of the back scattered signal due to the external disturbances to determine whether the external disturbances are applied to a point which is divided into the plurality of sections.

In the fifth step, a distance of the sensing optical fiber may be divided into a plurality of sections, back scattered signal values may be sampled and stored in each section for each order of pulses of the optical signal, and the stored signal values may be read to be compared for each pulse train so as to detect frequency characteristics of the external disturbances.

In the fifth step, a distance of the sensing optical fiber may be divided into a plurality of sections, back scattered signal values may be sampled and stored in each section for each order of pulses of the optical signal, and the stored signal values may be read to be compared for each position which is divided into the plurality of sections so as to detect the occurrence positions and the magnitude of the external disturbances.

In the fifth step, the sampled and stored signal values may be averaged for a preset time and the averaged values may be used.

### Advantageous Effects

The present disclosure is possible to more easily confirm intrusion occurrence, an intrusion position, and an intrusion object and perform a damage monitoring or prediction of the structure with higher sensitivity.

### DESCRIPTION OF DRAWINGS

FIG. 1 is a diagram illustrating a configuration of an apparatus for fiber optic perturbation sensing according to an exemplary embodiment of the present invention;

FIGS. 2A and 2B are diagrams for describing an operating principle of the apparatus for fiber optic perturbation sensing illustrated in FIG. 1, in which FIG. 2A is a diagram for describing a process of generating a sensing optical signal by a single pulse signal and emitting the generated optical signal through the sensing optical fiber and FIG. 2B is a diagram for describing a process of reflecting the sensing optical signal from the sensing optical fiber and returning the reflected sensing signal;

FIGS. 3A to 3C are diagrams illustrating an appearance of an interference sensing optical signal by a pulse signal continuously output from an optical signal generation unit;

FIG. 4 is a diagram illustrating in more detail an appearance of a change in a signal observed by an optical receiving unit when external disturbances do not exist;

FIG. 5 is a diagram illustrating in more detail the appearance of the change in a signal observed by the optical receiving unit when external disturbances are applied to point x;

FIG. 6 is a diagram illustrating in more detail the appearance of the change in a signal observed by the optical receiving unit when the external disturbances are simultaneously applied to points x and y;

FIG. 7A is a diagram conceptually illustrating a magnitude of the back scattering at (x, y) by setting the distance of the sensing optical fiber to be an x axis and the time(order) of the repeated pulse train to be a y axis;

FIG. 7B is a diagram illustrating that the measured signal is digitized and stored in a memory;

FIG. 8 is a diagram illustrating a configuration of an apparatus for fiber optic perturbation sensing according to another exemplary embodiment of the present invention; and

FIG. 9 is a diagram illustrating signal intensity depending on a phase difference of each signal in an interferometer of FIG. 8.

### BEST MODE

The present disclosure provides an apparatus for fiber optic perturbation sensing, including: a sensing optical fiber configured to sense external disturbances; an optical signal generation unit configured to output a pulse type of optical signal; an optical interference unit configured to divide an optical signal output from the optical signal generation unit, progress the divided optical signals to optical paths having different lengths, couple the divided optical signals to generate a sensing optical signal, output the sensing optical signal to the sensing optical fiber, divide the sensing optical signal returning from the sensing optical fiber, progress the divided sensing optical signals to the optical paths having different lengths, couple the divided sensing optical signals to generate an interference sensing optical signal, and output the interference sensing optical signal; an optical receiving unit configured to convert the interference sensing optical signal output from the optical interference unit into an electrical signal and output the electrical signal; and a signal processing unit configured to analyze the electrical signal output from the optical receiving unit to detect a position and a kind of external disturbances applied to the sensing optical fiber.

The present disclosure provides a method for fiber optic perturbation sensing, including: a first step of dividing a pulse type of optical signal and progressing the divided optical signals through optical paths having different lengths; a second step of coupling the optical signals progressed to the optical paths having different lengths and outputting the coupled optical signal to a sensing optical fiber; a third step of dividing the sensing optical signal returning from the sensing optical fiber and progressing the divided sensing optical signals to the optical paths having different lengths; a fourth step of coupling the sensing optical signals progressed to the optical paths having different lengths to generate an interference sensing optical signal; and a fifth step of analyzing the interference sensing optical signal to detect a position and a kind of external disturbances applied to the sensing optical fiber

### Method for Invention

Hereinafter, exemplary embodiments of the present invention will be described in more detail with reference to the accompanying drawings.

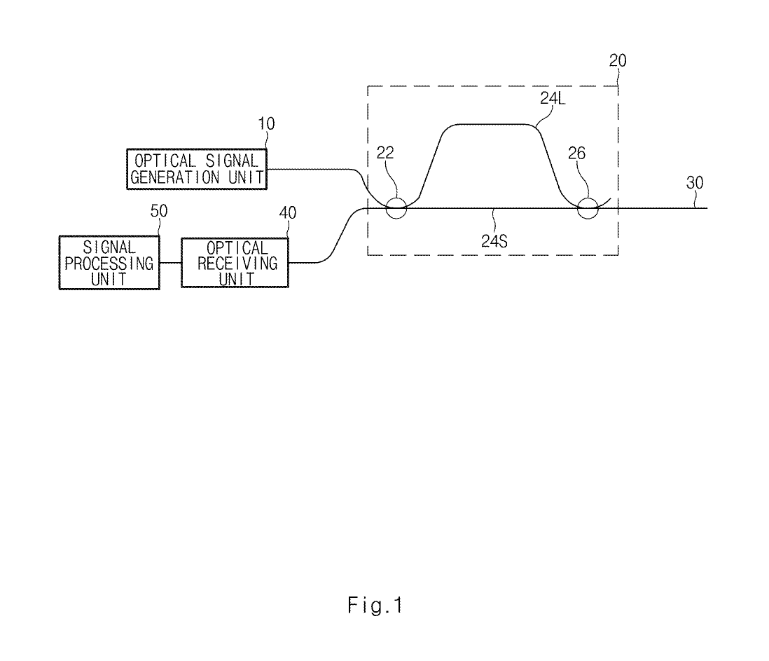

FIG. 1 is a diagram illustrating a configuration of an apparatus for fiber optic perturbation sensing according to an exemplary embodiment of the present invention.

The apparatus for fiber optic perturbation sensing according to an exemplary embodiment of the present invention includes an optical signal generation unit 10, an optical interference unit 20, a sensing optical fiber 30, an optical receiving unit 40, and a signal processing unit 50.

The optical signal generation unit 10 periodically outputs a pulse type of optical signal. The optical signal generation unit 10 may include a light source configured to generate an optical pulse and a driving unit configured to drive the light source. In this case, as the light source, a laser diode (LD), a super luminescent diode (SLD), an amplified spontaneous emission (ASE) light source using an erbium doped fiber (EDF), a light emitting diode (LED), and the like may be used. In particular, as the light source, a light source of a short wavelength (0.8 μm, 1.3 μm, and the like) is used, and causes more Rayleigh back scattering which is in inverse proportion to a wavelength to the power of 4 in the sensing optical fiber 30 to increase a magnitude of a reflection signal.

The optical interference unit 20 converts the optical pulse output from the optical signal generation unit 10 into a sensing optical signal having a plurality of continuous pulses and outputs the converted sensing optical signal to the sensing optical fiber 30. That is, the optical interference unit 20 divides the optical pulse output from the optical signal generation unit 10 into the plurality of optical pulses, progresses the divided optical pulses to paths having different lengths, and then couples the divided optical pulses again to generate the sensing optical signal having the plurality of continuous pulses. Further, the optical interference unit 20 overlaps some of the pulses of the sensing optical signal reflected and returning from the sensing optical fiber 30 to generate the interference sensing optical signal and outputs the generated interference sensing optical signal to the optical receiving unit 40. That is, the optical interference unit 20 divides the sensing optical signal reflected and returning from the sensing optical fiber 30 into the plurality of sensing optical signals, progresses the divided sensing optical signals through the optical paths having different lengths, and couples the divided sensing optical signals again to generate the interference sensing optical signal which is a overlapped signal of two pulses reflected at the same point (reflection point) with different times and outputs the generated interference sensing optical signal to the optical receiving unit 40. The optical interference unit 20 includes optical couplers 22 and 26 configured to divide a single input optical pulse into the plurality of optical pulse signals and couple the plurality of input optical pulse signals and optical paths 24S and 24L having different lengths L1 and L2 configured to be connected to the optical couplers 22 and 26. In this case, the optical couplers 22 and 26 are a directional coupler having a coupling ratio of 50% and a length difference (L1−L2) between the optical paths 24S and 24L is formed to be longer than a length of the optical pulse.

The sensing optical fiber 30 is connected to the optical interference unit 20 to sense the external disturbances. In this case, as the sensing optical fiber 30, an optical fiber with enhanced Rayleigh back scattering is preferably used to enhance the reflection signal by the back scattering. By the method, defects in an optical core can be increased or impurities may be added to the optical core. Alternatively, the sensing optical fiber is configured of a plurality of optical fiber cables, in which each of the optical fiber cables is connected to each other by a face contact/physical contact connector (FC/PC) to artificially generate Fresnel reflection generated at connection points between the optical fiber cables, thereby increasing the reflection signal. Alternatively, the core of the sensing optical fiber 30 is formed with an optical fiber grating to form the reflection point, thereby artificially increasing the reflection signal. Further, the sensing optical fiber 30 is not linearly routed and is wound in a spiral shape or a coil shape several times in a specific area in which the external disturbances are sensed, thereby improving sensitivity. Further, as the sensing optical fiber 30, a polarization-maintaining optical fiber is preferably used to remove a change in coherence depending on a polarization state.

The optical receiving unit 40 converts the interference sensing optical signal received through the optical interference unit 20 into an electrical signal in proportion to an intensity of the optical signal and outputs the electrical signal to the signal processing unit 50. As the optical receiving unit 40, a photo detector may be used.

The signal processing unit 50 analyzes the electrical signal of the optical receiving unit 40 to detect the positions of the external disturbances applied to the sensing optical fiber 30 and detect a kind of external disturbances, for example, whether the disturbances are due to an intrusion of an outsider, the disturbance is a disturbance due to a natural phenomenon such as wind, or the like. That is, the signal processing unit 50 measures the magnitude of back scattering at each position of the sensing optical fiber 30 over time, compares signals in an order of the optical pulses to detect frequency characteristics of the external disturbances, and compares the signals for each position to detect the occurrence positions and magnitude of the external disturbances.

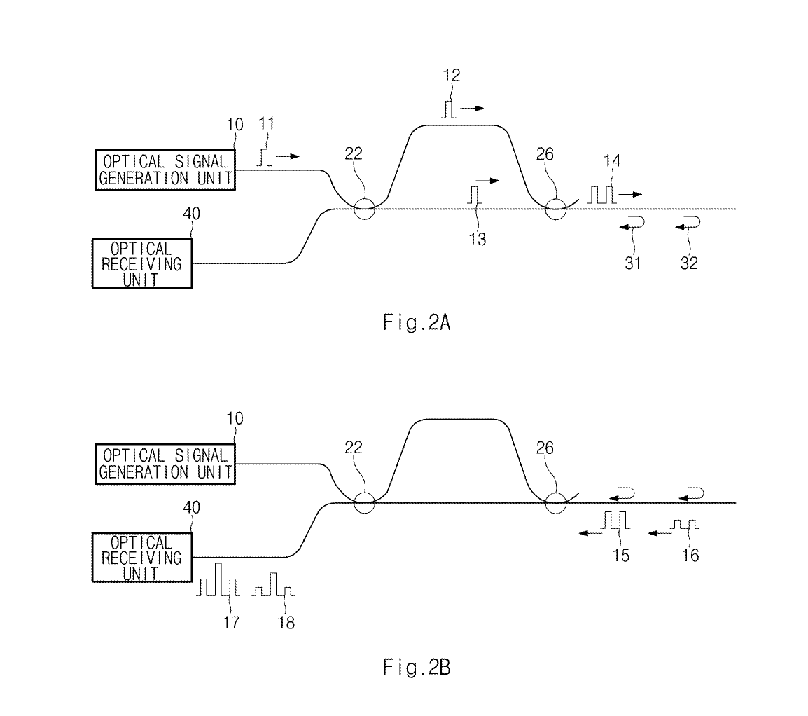

FIGS. 2A and 2B are diagrams for describing an operating principle of the apparatus for fiber optic perturbation sensing illustrated in FIG. 1, in which FIG. 2A is a diagram for describing a process of generating a sensing optical signal by a single pulse signal and emitting the generated optical signal through the sensing optical fiber and FIG. 2B is a diagram for describing a process of reflecting the sensing optical signal from the sensing optical fiber and returning the reflected sensing signal.

In FIGS. 2A and 2B, for convenience of explanation, the case in which one optical pulse signal is output from the optical signal generation unit 10 will be described.

One optical pulse 11 output from the optical signal generation unit 10 is divided into the same two pulses 12 and 13 in the optical coupler 22, each of the divided pulses 12 and 13 is progressed through the optical paths 24L and 24S having different lengths L1 and L2 and coupled with the sensing optical signal 14 by the optical coupler 26 and then enters the sensing optical fiber 30. In this case, when the length difference L1−L2 between the optical paths through which the two pulses 12 and 13 are progressed is set to be longer than the length of the optical pulse, the sensing optical signal 14 enters the sensing optical fiber 30 in a form in which the two pulses 12 and 13 are spatially completely separated from each other and then is progressed.

A portion of the sensing optical signal 14 progressed along the sensing optical fiber 30 is reflected at reflection points 31 and 32 by the Rayleigh back scattering which exists in the sensing optical fiber 30 and returns to the optical interference unit 20. The actual Rayleigh back scattering is distributedly generated in the whole of the sensing optical fiber 30, but for convenience of explanation, the exemplary embodiment of the present invention describes that the reflection is made only at the two points 31 and 32.

The sensing optical signals 15 and 16 reflected at the reflection points 31 and 32 are again divided by the optical coupler 26, progressed along the different optical paths 24L and 24S, coupled in the optical coupler 22, and then received in the optical receiving unit 40. In this case, signals 17 and 18 received by the optical receiving unit 40 is an interference sensing optical signal interfered by overlapping some of the sensing optical signals progressed along the different paths 24L and 24S and become pulse signals including three pulses per each of the reflection points 31 and 32.

A first pulse in the interference sensing optical signal 17 is a signal which is reflected from one reflection point 31 of the sensing optical fiber 30 and again returns through the short path 24S of the optical interference unit 20, after the optical pulse 11 output from the optical signal generation unit 10 is progressed through the short path 24S of the optical interference unit 20. Hereinafter, for convenience of explanation, the signal is called an SS pulse.

A third pulse in the interference sensing optical signal 17 is a signal that is reflected from one reflection point 31 of the sensing optical fiber 30 and again returns through the long path 24L of the optical interference unit 20, after the optical pulse 11 output from the optical signal generation unit 10 is progressed through the long path 24L of the optical interference unit 20. Hereinafter, for convenience of explanation, the signal is called an LL pulse.

An intermediate pulse in the interference sensing optical signal 17 is an overlapping signal between a signal (SL pulse) that is reflected from one reflecting point 31 of the sending optical fiber 30 and returns through the long path 24L of the optical interference unit 20, after the pulse 11 output from the optical signal generation unit 10 is progressed through the short path 24S of the optical interference unit 20 and a signal (LS pulse) that is progressed through the long path 24L of the optical interference unit 20, reflected from one reflection point 31 of the sensing optical fiber 30, and returns through the short path 24S of the optical interference unit 20. Hereinafter, for convenience of explanation, the overlapping signal is called SL/LS pulse. In this case, the SL pulse and the LS pulse are only in reverse order and progressed to the same optical path, such that the lengths of the optical paths of the two signals are the same, thereby generating the interference signal having high coherence. Generally, the coherence becomes high since the polarizations of two lights are the same. In the case of the SL/LS pulse, the polarization state of the SL pulse and the LS pulse may be changed depending on birefringence which exists in the optical fiber and the change in birefringence over time, and therefore the coherence of the interference signal may be changed depending on the change in surrounding environment. Therefore, the whole optical fiber is used as the polarization-maintaining optical fiber and therefore it is preferable to remove polarization dependency depending on the surrounding environment. Alternatively, an un-polarized light source may also be used in the optical signal generation unit 10.

The lengths of the optical paths through which the two signals (SL pulse and LS pulse) pass are the same, but the two signals pass through the reflection point 31 of the sensing optical fiber 30 at different times and therefore may be subjected to different phases at the time of passing through the reflection point 31. When the two signals (SL pulse and LS pulse) are subjected to the different phases, the magnitude of the SL/LS pulse is changed depending on the phase difference between the two signals, such that when the change is measured, the external disturbances may be sensed.

Only the interference sensing optical signal 17 reflected from the reflection point 31 is described above, but the interference sensing optical signal 18 reflected from the reflection point 32 is also generated by the same process as the interference sensing optical signal 17.

When the external disturbances occur between the two reflection points 31 and 32, the sensing optical signal 15 reflected from the reflection point 31 is not progressed to the points at which the disturbances occur, such that the intermediate pulse of the interference sensing optical signal 17 for the sensing optical signal 15 is not affected by the external disturbances. However, since the sensing optical signal 16 reflected from the reflection point 32 is progressed to the point at which the disturbances occur, the sensing optical signal 16 is affected by the external disturbances and thus the magnitude of the intermediate pulse of the interference sensing optical signal 18 is changed. Therefore, the change in the magnitude of the interference sensing optical signals 17 and 18 returning from each of the reflection points 31 and 32 is analyzed using the above principle to be able to sense whether the disturbances occur and the positions of the external disturbances.

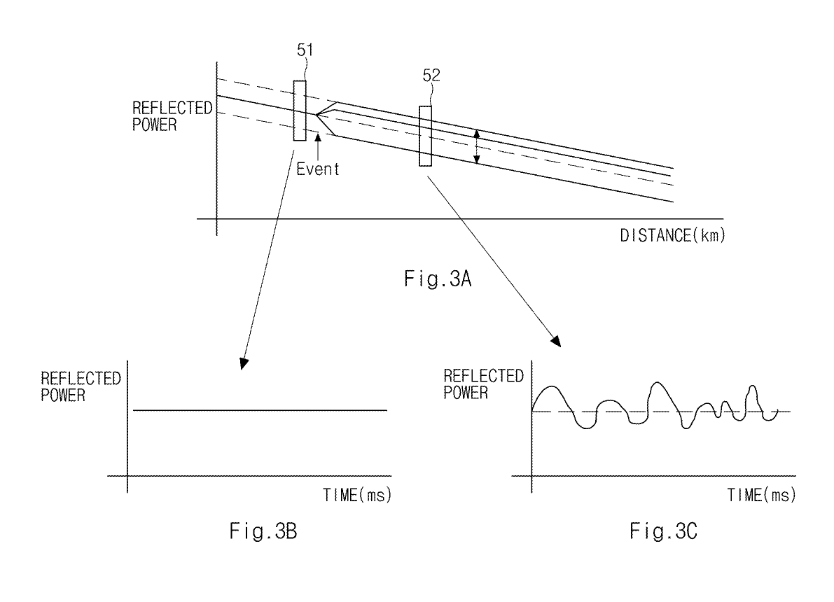

FIGS. 3A to 3C are diagrams illustrating an appearance of the interference sensing optical signal by the optical pulse continuously output from the optical signal generation unit.

In FIGS. 2A and 2B, for convenience of explanation, the case in which the sensing optical signal is reflected from the two independent reflection points 31 and 32 is described by way of example. However, when the Rayleigh back scattering is used to actually sense the positions of the disturbances, since the reflection points very closely exist continuously, the sensing optical signal is reflected in a distributed reflection form and therefore the signal received by the optical receiving unit 40 is shown in a continued line as illustrated in FIG. 3A, not in an independent pulse train as illustrated in FIGS. 2A and 2B.

In this case, when observing the signal returning to the optical receiving unit 40 while the optical signal generation unit 10 continuously outputs the optical pulse, a magnitude of a signal 51 returning without reaching a positions (event position) at which the external disturbances exist is not changed as illustrated in FIG. 3B but a magnitude of a signal 52 returning after passing through the positions at which the external disturbances exist is changed by the external disturbances as illustrated in FIG. 3C.

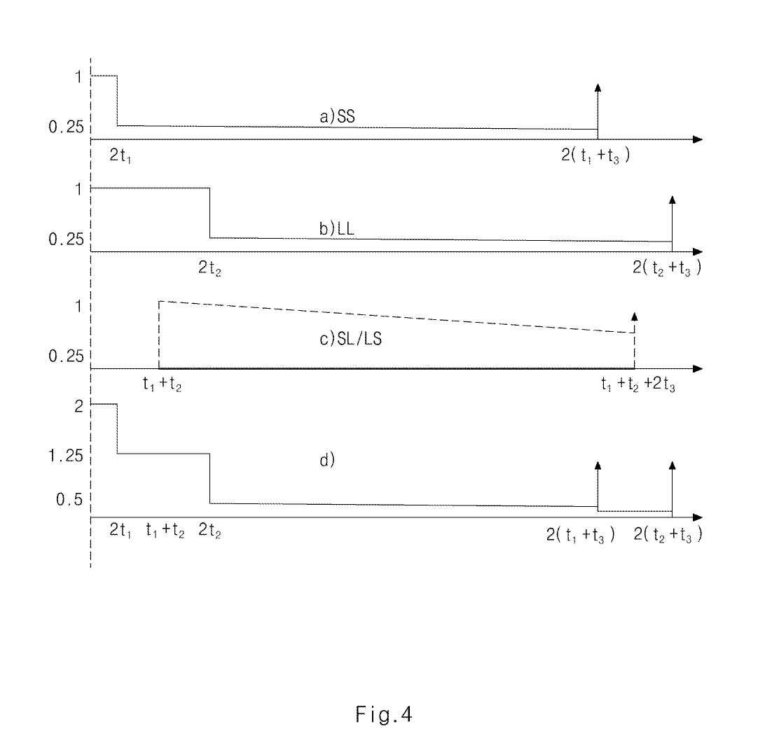

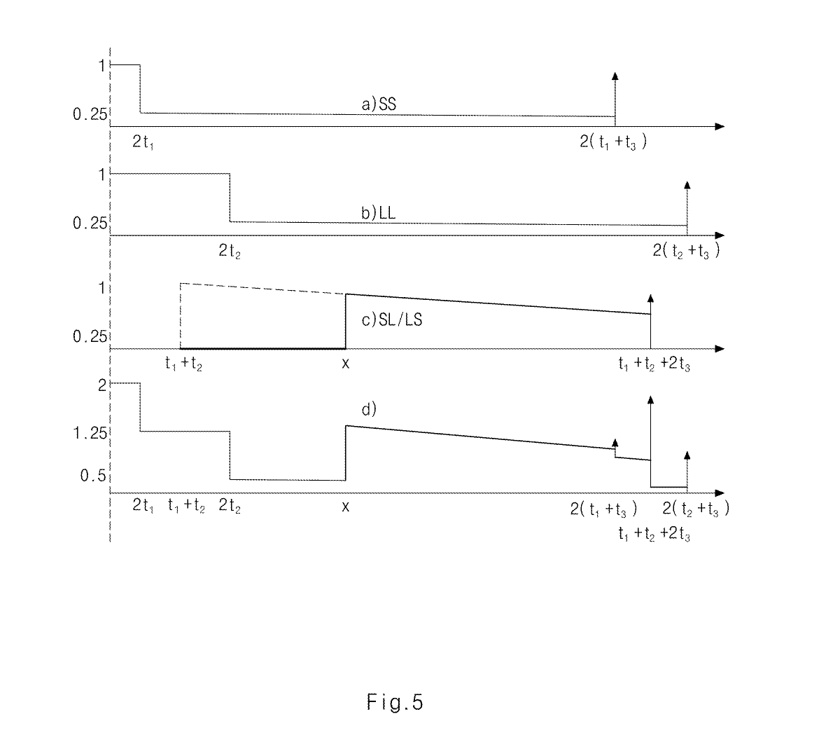

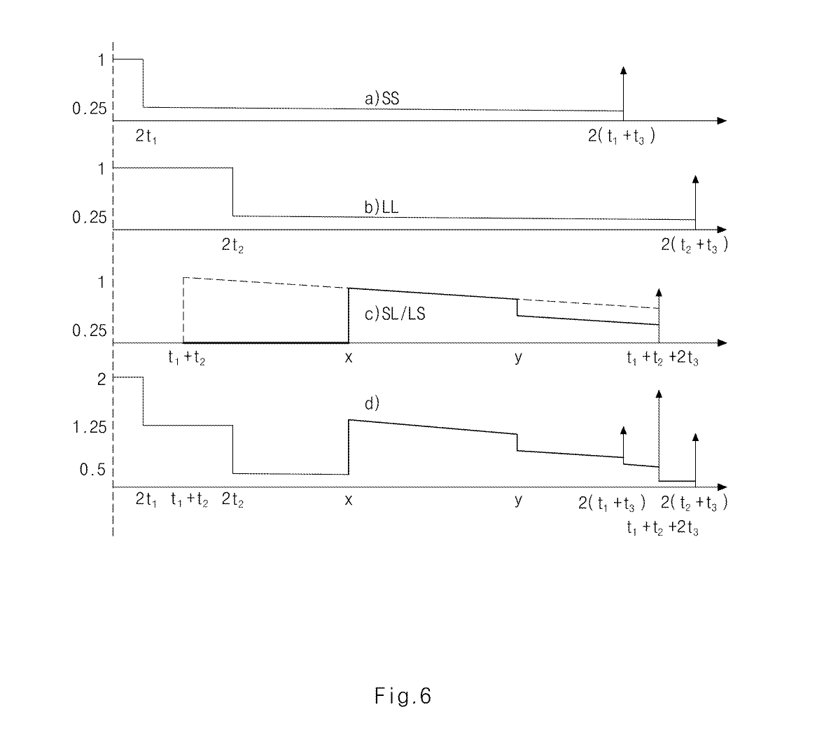

FIGS. 4 to 6 are diagrams in more detail the appearance of the change in the signal, which is observed by the optical receiving unit, depending on the external disturbances, in which FIG. 4 illustrates the appearance of the signal when the external disturbances do not exist, FIG. 5 illustrates the appearance of the signal when the external disturbances are applied to point x, and FIG. 6 illustrates the appearance of the signal when the external disturbances are simultaneously applied to points x and y.

Herein, a progress time of light in the short path 24S of the optical interference unit 20 is assumed to be t1, a progress time of light in the long 24L is assumed to be t2, and a progress time of light in the sensing optical fiber 30 is assumed to be t3. The lengths of each path may be set as a condition of t1<t2<<t3. Further, the optical couplers 22 and 26 is a 2×2 directional coupler having a coupling ratio of 50% and the optical signal passing through the couplers 22 and 26 are divided into both arms and thus light is divided in half and compared with the case in which light passes through as it is, the light coupled with an opposite arm has a phase difference of π/2.

First, the case in which no external disturbance exists will be described below with reference to FIG. 4.

The SS pulse starts from the optical signal generation unit 10, is incident on the sensing optical fiber 30 via the short path 24S of the optical interference unit 20, is distributedly reflected from the whole of the sensing optical fiber 30, and is again incident on the optical receiving unit 40 via the short path 24S of the optical interference unit 20.

In this case, every time when the light pass through the directional couplers 22 and 26, light intensity is reduced to a half (reduced by 3 dB) and the Rayleigh back scattering occurs in the optical fiber configuring the optical interference unit 20 as well as in the sensing optical fiber 30. Therefore, since the optical pulse output from the optical signal generation unit 10 passes through the coupler 22 and then is directly back-scattered in the short path 24S, when a relative intensity of light which is again incident on the optical receiving unit 40 via the coupler 22 is set to be “1”, the magnitude of the back scattering over the time of the SS pulse is the same as signal a) illustrated in FIG. 4. That is, the intensity of the optical pulse is set to be “1” for the time (˜2 t1) when the optical pulse returns by being back-scattered within the short path 24S and since the optical pulse reciprocally passes through the coupler 26 twice more for the time (2 t1−2 (t1+t3)) when the optical pulse is incident on the sensing optical fiber 30 via the coupler 26 and returns by being back-scattered in the sensing optical fiber 30, the intensity of the optical pulse is reduced to ¼ and thus becomes 0.25. In particular, the intensity is reduced toward a back portion of the sensing optical fiber 30 due to the back scattering accumulated at a front portion thereof while the optical pulse is progressed to the sensing optical fiber 30. Further, a reflection peak may appear at 2 (t1+t3) by Fresnel reflection at an end of the sensing optical fiber 30. This is shown by an arrow at 2 (t1+t3). In signal a), the signal is similar to a general OTDR signal, excepting for a signal up to 2 t1 by the optical interference unit 20.

Compared with the SS pulse, the LL pulse is the same as the SS pulse, having the difference only in that the LL pulse is progressed to the long path 24L within the optical interference unit 20. Therefore, since the optical pulse output from the optical signal generation unit 10 passes through the coupler 22 and then is directly back-scattered in the long path 24L, when a relative intensity of light which is again incident on the optical receiving unit 40 via the coupler 22 is set to be “1”, the magnitude of the back scattering over the time of the LL pulse is the same as signal b) illustrated in FIG. 4.

The SL/LS pulse is an overlapping pulse of back scattering of the two pulses 12 and 13 which are progressed through the same path in reverse order and the magnitude of the SL/LS pulse is changed depending on the phase difference of the two pulses. Only the back scattering at the sensing optical fiber 30 is contributed to the SL/LS pulse. Therefore, the signal is generated from t1+t2 which is the time when the signal is progressed to the short path 24S and the long path 24L of the optical interference unit 20 and is continued up to t1+t2+t3 when the back scattering occurs at the end of the sensing optical fiber 30. Even in this case, the reflection peak may appear at t1+t2+2 t3 by the Fresnel reflection at the end of the sensing optical fiber 30. The magnitude of the interference signal of the back scattering over the time of the SL/LS pulse is the same as c) signal. A dotted line represents a magnitude of a maximum signal which may occur due to the interference and the intensity thereof is also reduced toward the back portion due to the back scattering accumulated at the front portion. The magnitude of the signal may be changed from a maximum value to “0” due to the external disturbances and when no external disturbance is exist, the SL pulse and the LS pulse have a phase difference of π to each other and therefore a destructive interference occurs, such that the magnitude thereof becomes “0”.

A final signal in the optical receiving unit 40 has a coupled form of the SS pulse, the LL pulse, and the SL/LS pulse and generally, the three signals are coupled while delayed more than a coherence time and therefore have a form in which the intensities of the three signals are summed, as in signal d). When no external disturbance exists, the SL/LS pulse is “0”, such that the final signal in the optical receiving unit 40 becomes a sum of the SS pulse and the LL pulse as in signal d).

Next, the case in which the external disturbances are applied to point x and the phase difference is π will be described below with reference to FIG. 5. This corresponds to the case in which the phase difference of π is applied due to the external disturbances while the SL pulse is progressed and no disturbance exists while the LS pulse is progressed.

First, the SS pulse and the LL pulse are the signal of the simple Rayleigh back scattering, not the interference signal and are the same as the signal in the case in which no external disturbance exists. Therefore, the form of signals a) and b) of FIG. 5 is the same as a) and b) of FIG. 4. However, when a light loss largely occurs at the disturbance point due to the external disturbances, a step may occur at the disturbance point.

In the SL/LS pulse, the back-scattered light before point x are not subjected to the external disturbances, and therefore the light intensity still becomes “0”. On the other hand, the back-scattered light after point x are additionally subjected to the phase difference of π, the light are subjected to a constructive interference and therefore becomes a maximum intensity (four times of the SS pulse or the LL pulse), and the signal form thereof is as illustrated in c).

The final signal in the optical receiving unit 40 has a form like signal d) in which a) SS pulse, b) LL pulse, and c) SL/LS pulse are coupled. Compared with signal d) of FIG. 4, a step occurs at point x due to the constructive interference and therefore it may be appreciated that the external disturbances are applied to point x. Further, the magnitude of the external disturbances may be inferred.

Next, the case in which the external disturbances are applied to points x and y will be described with reference to FIG. 6. This corresponds to the case in which the phase difference of π/2 is additionally applied to point y while the SL pulse is progressed and no disturbance exists while the LS pulse is progressed.

In the case of the SS pulse and the LL pulse, this case is the same as one illustrated in FIGS. 4 and 5. That is, the signal form of a) and b) is the same as the signal form of a) and b) illustrated in FIGS. 4 and 5.

In the case of the SL/LS pulses, the back scattered light before point x is not subjected to the external disturbances and therefore the light intensity still becomes “0”, and all of the back scattered light has the phase difference of π from point x to point y and therefore as illustrated in FIG. 5, is subjected to the constructive interference and becomes the maximum intensity (four times of the SS pulse or the LL pulse). Further, the phase change of π/2 is additionally applied after point y and thus the phase difference becomes π+π/2, such that the signal form thereof becomes an intermediate intensity (twice of the SS pulse or the LL pulse) like c).

The final signal in the optical receiving unit 40 has a form like d) in which a) SS pulse, b) LL pulse, and c) SL/LS pulse is coupled. Compared with signal d) of FIG. 4, a step occurs at points x and y due to the change in the intensity of the interference signal and therefore it may be appreciated that the external disturbances are applied to points x and y. Further, the magnitude of the external disturbances may be inferred. That is, even when the external disturbances are simultaneously applied to several points, all the positions at which the disturbances are applied may be appreciated by analyzing the final signal.

As such, even when the disturbances continuously occur at several places, the optical signal generation unit 10 continuously generates repeatedly the pulse signal and outputs the generated pulse signal and then analyze the signal received by the optical receiving unit 40 for each pulse, such that the positions of the disturbances and the frequency and the magnitude of the disturbance signal may be detected.

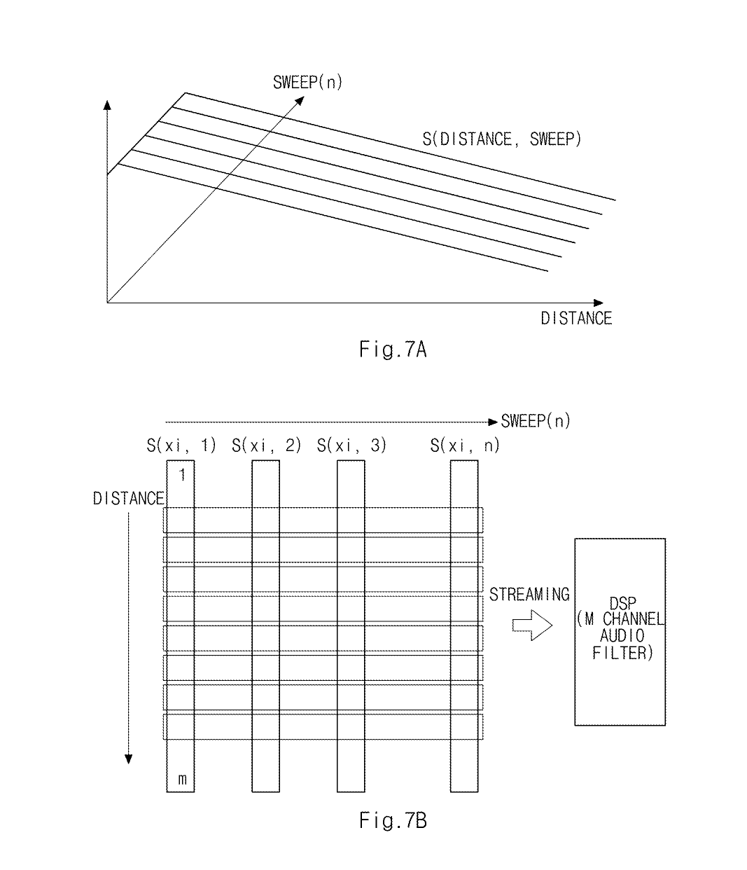

FIGS. 7A and 7B are diagrams for describing a signal processing method of the signal processing unit 50 in the sensing apparatus of FIG. 1.

Referring to FIGS. 7A and 7B, as illustrated in FIG. 6, when the external disturbances are applied to several points of the sensing optical fiber 30, a method for discriminating a kind of external disturbances (intrusion of outsider, natural phenomenon, and the like) by searching the occurrence positions of the external disturbances from the final signal received by the optical receiving unit 40 and analyzing the magnitude, the frequency characteristics, and the like of the external disturbances will be described in more detail.

As described above, one optical pulse output from the optical signal generation unit 10 is back-scattered in the sensing optical fiber 30 to generate the signal like d) of FIG. 6 every time the back-scattered optical pulse reaches the optical receiving unit 40. In this case, in FIG. 6, a time base is a value proportional to a distance (position) of the sensing optical fiber 30. Therefore, when the optical signal generation unit 10 continuously generates repeatedly the pulse signal and outputs the generated pulse signal and continuously measures the signal received by the optical receiving unit 40, the magnitude of the back scattering may be measured at each position of the sensing optical fiber 30 over time. In this case, a repetition ratio of the optical pulse repeatedly output from the optical signal generation unit 10 corresponds to a sampling rate which measures the back scattering at each point. Therefore, as the repetition ratio is fast, the external disturbances of high frequency may be sensed. This is limited by 2 (t2+t3) which is the time when the light progressed to the longest path returns. That is, when a total length of the long path 24L of the optical interference unit 20 and the sensing optical fiber 30 is 20 km, 2 (t2+t3) becomes 200 μs and therefore the pulse repetition ratio is limited to 5 kHz, such that the measurable maximum frequency of the external disturbances is limited to 2.5 kHz. Therefore, as the maximum measuring distance (length of the sensing optical fiber) is increased, a measuring rate is slow.

FIG. 7A conceptually illustrates the magnitude S (distance, sweep) of the back scattering at (x, y) by setting the distance (distance=xi) of the sensing optical fiber 30 to be an x axis and the time(order) (sweep(n)) of the repeated pulse train to be a y axis. In this case, the back scattered signal S for each order of the pulse trains like d) of FIG. 6 is simply represented in a straight line.

FIG. 7B is a diagram illustrating that the measured signal S is digitized and stored in a memory, in which in S (xi, n) of FIG. 7B, xi represents the digitized distance of the sensing optical signal and n represents an order (sweep order) of the pulse trains.

That is, the signal processing unit 50 divides the distance (xi) of the sensing optical fiber 30 into m sections and then samples the signal value S (xi, n) back-scattered in each section for each order of the pulse trains and stores the sampled signal value in the memory. In this case, an interval of the distance section is generally set to be a spatial resolution of the sensing apparatus. The spatial resolution is in inverse proportion to a pulse width. Therefore, in the case of the pulse width of 10 ns in an optical fiber for communication, the spatial resolution is 1 m and in the case of the pulse width of 100 ns, the spatial resolution is 10 m.

When the optical pulse having the pulse width of 100 ns is used, the sensing optical fiber 30 of 20 km is divided into 2000 (m=2000) sections and a minimum delay line (difference between the long path and the short path in the optical interference unit) determined by the pulse width is set to be 20 m. As the delay line is long, since the time difference between the two interfering pulses is large, the delay line of several hundreds of m to 1 km may be required to measure the external disturbances at audio frequency range.

When the signal processing unit 50 sequentially reads the signal values for each pulse for each distance (xi) of the sensing optical fiber from the memory and analyzes the read signal values, as illustrated in FIG. 3C, the change in the magnitude of the back scattered signal due to the external disturbances at the specific point may be detected. Therefore, the signal processing unit 50 may simultaneously measure whether the external disturbances are applied to m points.

Further, the signal processing unit 50 compares the read signal values from the memory for each pulse train to detect the frequency characteristics of the external disturbances and compares the signal values for each position (xi) to detect the occurrence positions and the magnitude of the external disturbances.

However, since the change in the magnitude due to the external disturbance of the interference pulse of the back scattered light is generally small, to improve a signal to noise ratio (SNR), the signal values of each order of the pulse trains stored in the memory are averaged for an appropriate time to analyze the signal. Since when the average time is long, the change in high frequency may not be measured and when the average time is short, the signal to noise ratio is reduced, the average time is determined in consideration of the magnitude and the frequency of the external disturbances.

Further, the signal processing unit 50 compares a value obtained by averaging the signal values stored in the memory while no external disturbance exist for a preset time with a value obtained by averaging the signal values stored in the memory while the external disturbances are applied for a preset time to determine whether the external disturbances are applied.

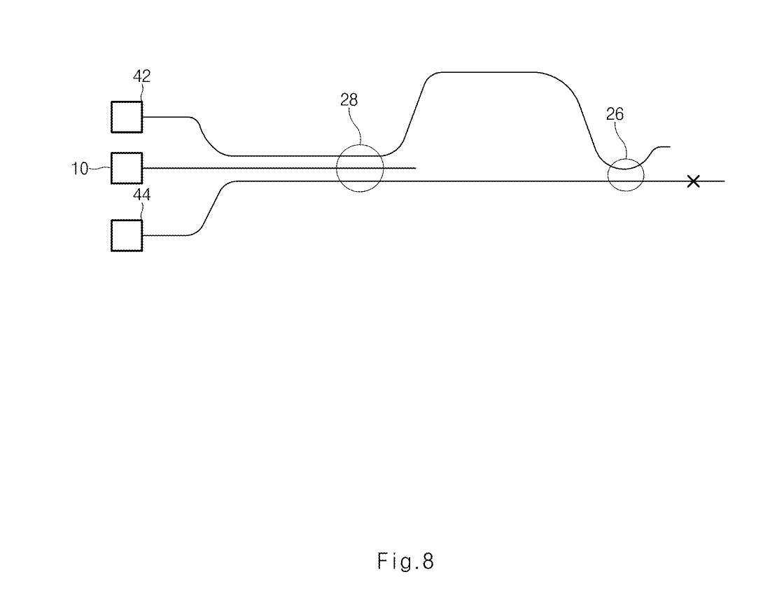

FIG. 8 is a diagram illustrating a configuration of an apparatus for fiber optic perturbation sensing according to another exemplary embodiment of the present invention.

In FIG. 8, to reduce the degradation in the signal to noise ratio due to the intensity noise of the optical pulse generated from the optical signal generation unit 10 and improve the sensitivity, in the optical interference unit 20 of FIG. 1, the optical coupler 22 is replaced by a 3×3 optical coupler 28. Therefore, a middle port of the optical coupler 28 is connected with the optical signal generation unit 10 and upper and lower ports are each connected with the optical receiving units 42 and 44. Further, the upper and lower ports of the other end of the optical coupler 28 are connected with both ports of the optical coupler 26 through the long path 24L and the short path 24S to configure the optical interferometer.

At the time of configuring the optical interferometer as illustrated in FIG. 8, a principle of improving the signal to noise ratio and the sensitivity will be described as follows.

When the interference signal due to the back scattered light at any point (point x) of the sensing optical fiber 30 is observed at a middle port s and upper and lower ports p1 and p2, the change in intensity is like the following Equation.

Iₛ=I₀(1|cos ΔΦ(x))

Iₚ₁=I₀(1+cos(ΔΦ(x)−2π/3))

Iₚ₂=I₀(1+cos(ΔΦ(x)+2π/3))

In the above Equation, Iₒ represents an amount proportional to the intensity of back scattered light at point x of the sensing optical fiber 30 and ΔΦ(x) represents the phase difference at point X when the SL pulse and the LS pulse passes.

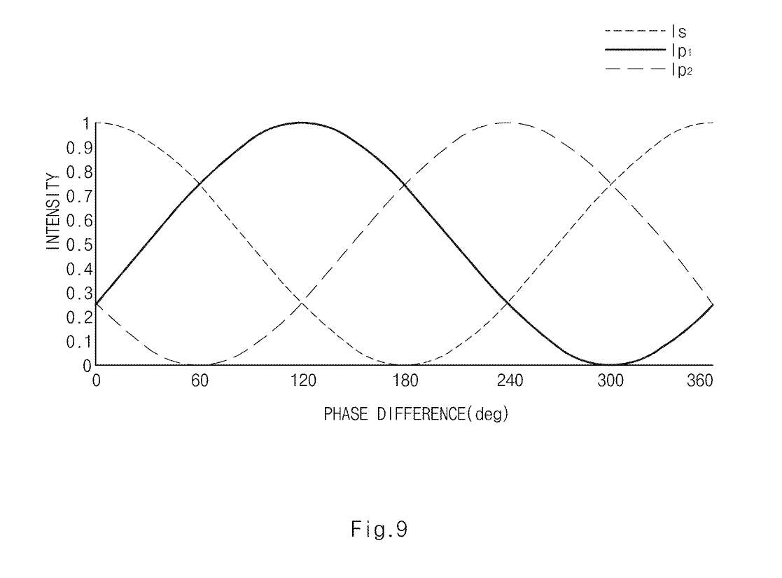

The light intensity of the three interference signals has a phase difference of 2π/3 (120°) among them and the intensity of the signal depending on the phase difference of each signal is represented as illustrated in FIG. 9.

A difference and a sum between signals observed by the optical receiving units 42 and 44 connected to the upper and lower ports are obtained as the following Equation.

Iₚ₁−Iₚ₂=\sqrt{3}I₀ sin ΔΦ(x)

Iₚ₁+Iₚ₂=I₀(2−cos ΔΦ(x))

When the phase difference ΔΦ(x) is obtained using the difference of the signals observed by the optical receiving units 42 and 44, the general OTDR signal (in FIG. 4, a) SS signal, b) LL signal) basically existing is removed and thus the influence due to the intensity noise of the light source may be reduced. Further, the intensity of Ip₁ and Ip₂ are changed in an opposite direction to each other depending on the phase difference and thus the sensitivity (to be accurate, scale factor) may be improved.

When the signal is normalized by dividing the difference (Ip₁−Ip₂) of the signals by the sum (Ip₁+Ip₂) of the signals, an Equation for the phase difference independent of the light intensity Iₒ may be obtained.

The exemplary embodiments of the present invention described above have been provided for illustrative purposes. Therefore, those skilled in the art will appreciate that various modifications, alterations, substitutions, and additions are possible without departing from the scope and spirit of the invention as disclosed in the accompanying claims and such modifications, alterations, substitutions, and additions fall within the scope of the present invention.

According to the foregoing exemplary embodiments, a phase modulator is further provided in one path of the optical interference unit 20 to make the phases of the SL pulse and the LS pulse progressed to the phase modulator at different times different, thereby improving the signal to noise ratio.

That is, the phase modulation of a sine wave form is performed by using the phase modulator and demodulation is again performed or a harmonic component of the phase modulation frequency is analyzed, thereby improving the signal to noise ratio. Alternatively, when the phase modulator is driven to generate a constant phase difference of π/2 in the two signals at the moment that the SL pulse and the LS pulse pass, the interference signal has a quadrature phase, and therefore the sensitivity may be improved.

Further, a depolarizer is further provided in any one path of the optical interference unit 20 or between the optical signal generation unit 10 and the optical interference unit, thereby removing the polarization dependency of the optical signal.

Further, the foregoing exemplary embodiments described that the signal processing unit 50 stores all the signals received by the optical receiving unit 40 in the memory and always analyzes the stored signals, but in this case, the unnecessary data storage and analysis need to be performed, and therefore the degradation in efficiency may be caused. Since the Fresnel reflection magnitude of the end of the sensing optical fiber 30 is much larger than the magnitude of the back scattering, when the external disturbances are applied to the sensing optical fiber 30, the change in the Fresnel reflection signal may be easily measured. Therefore, only when the Fresnel reflection signal of the end of the sensing optical fiber 30 is changed, the signal processing unit 50 may store the received interference signal or precisely analyze the corresponding signal. That is, to efficiently manage the measurement result and analyze the detailed signal, the Fresnel reflection signal of the end of the sensing optical signal 30 may be used as a trigger signal, a signal confirming whether an event is generated, an alarm signal, a starting signal of precise signal analysis for event occurrence place and characteristics, and the like.

### INDUSTRIAL APPLICABILITY

According to the exemplary embodiments of the present invention, it is possible to more easily confirm whether the intrusion is occurred, the intrusion place, and the intrusion object and perform the destruction monitoring or prediction of the structure with higher sensitivity.

1. An apparatus for fiber optic perturbation sensing, the apparatus comprising:
a sensing optical fiber configured to sense external disturbances;
an optical signal generation unit configured to output a pulse type of optical signal;
an optical interference unit configured to divide an optical signal output from the optical signal generation unit, progress the divided optical signals to optical paths having different lengths, couple the divided optical signals to generate a sensing optical signal, output the sensing optical signal to the sensing optical fiber, divide the sensing optical signal returning from the sensing optical fiber, progress the divided sensing optical signals to the optical paths having different lengths, couple the divided sensing optical signals to generate an interference sensing optical signal, and output the interference sensing optical signal;
an optical receiving unit configured to convert the interference sensing optical signal output from the optical interference unit into an electrical signal and output electrical signal; and
a signal processing unit configured to analyze the electrical signal output from the optical receiving unit to detect a position and a kind of external disturbances applied to the sensing optical fiber.

2. The apparatus of claim 1, wherein the sensing optical fiber is an optical fiber with enhanced Rayleigh back scattering.

3. The apparatus of claim 1, wherein the sensing optical fiber includes a plurality of optical fiber cables which are connected by a face contact/physical contact connector (FC/PC).

4. The apparatus of claim 1, wherein the sensing optical fiber includes a reflecting point using an optical fiber grating.

5. The apparatus of claim 1, wherein the sensing optical fiber is a polarization-maintaining optical fiber.

6. The apparatus of claim 1, wherein the optical signal generation unit includes an un-polarized light source.

7. The apparatus of claim 1, wherein the optical signal generation unit includes:
any one of a laser diode (LD), a super luminescent diode (SLD), an amplified spontaneous emission (ASE) light source using an erbium doped fiber (EDF), and a light emitting diode (LED).

8. The apparatus of claim 1, wherein the optical signal generation unit includes a light source of a short wavelength.

9. The apparatus of claim 1, wherein the optical interference unit includes:
a first optical coupler configured to divide an optical signal input from the optical signal generation unit and output the divided optical signal to optical paths having different lengths, couple the optical signals input from the optical paths having different lengths, and output the coupled optical signal to the optical receiving unit; and
a second optical coupler configured to couple the optical signals input from the optical paths having different lengths, output the coupled optical signal to the sensing optical fiber, divide the optical signal input from the sensing optical fiber, and output the divided optical signals to the optical paths having different lengths.

10. The apparatus of claim 9, wherein the first optical coupler is a 2×2 optical coupler whose both ports of one portion are connected to the optical signal generation unit and the optical receiving unit and both ports of the other portion are connected to the optical paths having different lengths.

11. The apparatus of claim 9, wherein the first optical coupler is a 3×3 optical coupler whose middle port of one portion is connected to the optical signal generation unit, upper and lower ports of the one portion are connected to first and second optical receiving units, and upper and lower ports of the other portion are connected to the optical paths having different lengths.

12. The apparatus of claim 10, wherein the second optical coupler is a 2×2 optical coupler whose both ports of one portion are connected to the optical paths having different lengths and one port of the other portion is connected to the sensing optical fiber.

13. The apparatus of claim 1, wherein the optical paths having different lengths, a difference between the paths is longer than a pulse length of the optical signal.

14. The apparatus of claim 1, further comprising:
a depolarizer configured to be provided in one path of the optical interference unit or between the optical signal generation unit and the optical interference unit.

15. The apparatus of claim 1, further comprising:
a phase modulator configured to be provided in one path of the optical interference unit.

16. The apparatus of claim 1, wherein the signal processing unit divides a distance of the sensing optical fiber into a plurality of sections, samples signal values which are back scattered in each section for each order of pulses of the optical signal and received in the optical receiving unit, and stores the sampled signal values in a memory.

17. The apparatus of claim 16, wherein the signal processing unit sequentially reads the signal values stored in the memory for each pulse for each distance of the sensing optical fiber to detect a change in a magnitude of a back scattered signal due to external disturbances at a specific point so as to determine whether the external disturbances are applied to points which are divided into the plurality of sections.

18. The apparatus of claim 16, wherein the signal processing unit compares the signal values stored in the memory for each pulse train to detect frequency characteristics of the external disturbances.

19. The apparatus of claim 16, wherein the signal processing unit compares the signal values stored in the memory for each position which is divided into the plurality of sections to detect the occurrence positions and the magnitude of the external disturbances.

20. The apparatus of claim 17, wherein the signal processing unit averages the signal values stored in the memory for a preset time and uses the averaged values.

21. The apparatus of claim 20, wherein the signal processing unit compares a value obtained by averaging the signal values stored in the memory while no external disturbance exist for a preset time with a value obtained by averaging the signal values stored in the memory while the external disturbances are applied for a preset time to determine whether the external disturbances are applied.

22. The apparatus of claim 17, wherein the signal processing unit performs a determination on whether the external disturbances are applied, a detection of the frequency characteristics of the external disturbances, or a detection of the occurrence positions and the magnitude of the external disturbances, only when a Fresnel reflection signal generated at an end of the sensing optical fiber is changed.

23. A method for fiber optic perturbation sensing, the method comprising:
a first step of dividing a pulse type of optical signal and progressing the divided optical signals through optical paths having different lengths;
a second step of coupling the optical signals progressed to the optical paths having different lengths and outputting the coupled optical signal to a sensing optical fiber;
a third step of dividing the sensing optical signal returning from the sensing optical fiber and progressing the divided sensing optical signals to the optical paths having different lengths;
a fourth step of coupling the sensing optical signals progressed to the optical paths having different lengths to generate an interference sensing optical signal; and
a fifth step of analyzing the interference sensing optical signal to detect a position and a kind of external disturbances applied to the sensing optical fiber.

24. The method of claim 23, wherein the first step, the optical signal is subjected to two division and progresses the divided optical signals to different optical paths having a path difference longer than a pulse length of the optical signal.

25. The method of claim 23, wherein the third step, the sensing optical signal returning from the sensing optical fiber is subjected to two division and progresses the divided sensing optical signals to the different optical paths in a reverse direction.

26. The method of claim 23, wherein a preset constant phase difference additionally occurs in the optical signal which is progressed to a short optical path in the first step and then progressed to a long optical path in the third step and the optical signal which is progressed to the long optical path in the first step and then progressed to the short optical path in the third step.

27. The method of claim 23, wherein the fifth step, a distance of the sensing optical fiber is divided into a plurality of sections, back scattered signal values are sampled and stored in each section for each order of pulses of the optical signal, and the stored signal values are sequentially read for each pulse for each distance of the sensing optical fiber to detect a change in a magnitude of the back scattered signal due to the external disturbances to determine whether the external disturbances are applied to a point which is divided into the plurality of sections.

28. The method of claim 23, wherein the fifth step, a distance of the sensing optical fiber is divided into a plurality of sections, back scattered signal values are sampled and stored in each section for each order of pulses of the optical signal, and the stored signal values are read to be compared for each pulse train so as to detect frequency characteristics of the external disturbances.

29. The method of claim 23, wherein the fifth step, a distance of the sensing optical fiber is divided into a plurality of sections, back scattered signal values are sampled and stored in each section for each order of pulses of the optical signal, and the stored signal values are read to be compared for each position which is divided into the plurality of sections so as to detect the occurrence positions and the magnitude of the external disturbances.

30. The method of claim 27, wherein the fifth step, the sampled and stored signal values are averaged for a preset time and the averaged values are used.
